(19) United States
(12) Patent Application Publication
(10) Pub. No.: US 2009/0204676 A1
(43) Pub. Date: Aug. 13, 2009

(54) CONTENT BASED ROUTING OF MISADDRESSED E-MAIL

(75) Inventors: Ian Westbrook Parkinson, Eastleigh (GB); Christopher Francis Robertson Markes, Hampshire (GB)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/029,155

(22) Filed: Feb. 11, 2008

(51) Int. Cl. G06F 15/16

(52) U.S. Cl. 709/206

(57) ABSTRACT

An e-mail routing system includes an e-mail program on a plurality of computers using a network for an e-mail system to minimize receipt of misaddressed e-mails. A knowledge base or database contains reference data associated with each of the recipient e-mail addresses in the e-mail system. A content analyzer program analyzes e-mail content data. A relevancy score generator program generates a relevancy score for each e-mail recipient. The relevancy score is derived from associating the reference data corresponding to each possible recipient e-mail addresses with the e-mail data. A specified minimal relevancy score is selected and low relevancy score recipient e-mails are associated by the content analyzer program with a plurality of possible recipient e-mail addresses having high relevancy scores. The relevancy score generator program selects at least one recipient from the possible recipient e-mail addresses and initiates sending the selected recipient the corresponding e-mail(s) using the e-mail program.

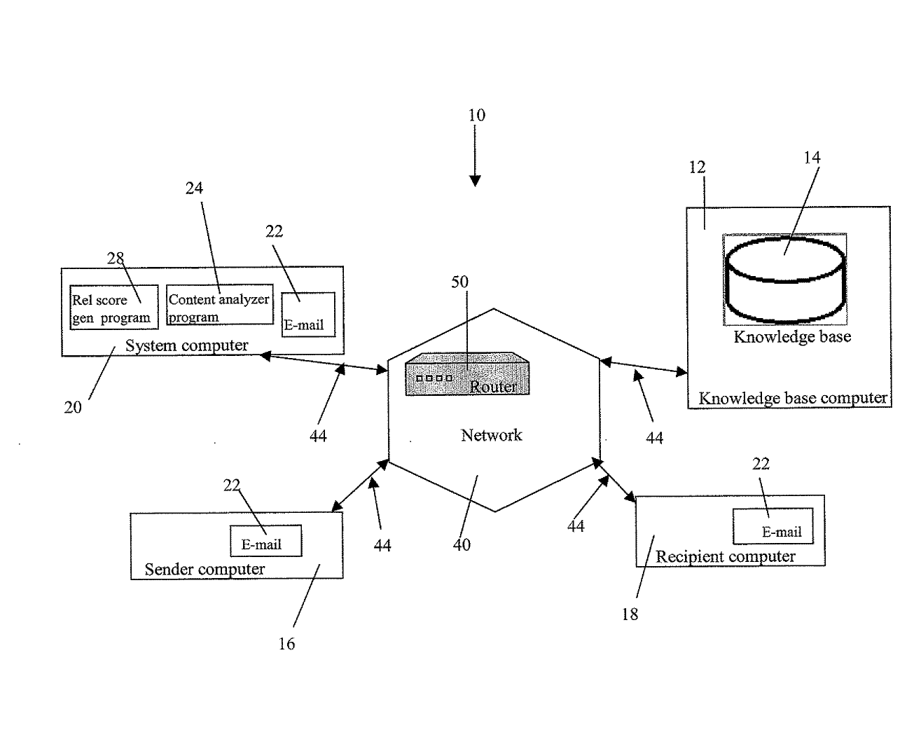

### FIELD OF THE INVENTION

The present invention relates to an e-mail routing system and method for re-rerouting misaddressed e-mails, and more specifically, relates to analyzing e-mail contents to determine relevancy of the e-mail to the recipient of the e-mail.

### BACKGROUND OF THE INVENTION

E-mail is a popular and standard means of communication particularly within large organizations. Typically, an e-mail system or program allows for deployment of an electronic address book which allows the user (or the email application) to select a recipient's e-mail address based on their real name.

One problem with known e-mail systems occurs when people with similar names are listed in the address book of the e-mail system. In this case users cannot rely on the e-mail application to select the correct recipient based purely on their name. Instead, users will often inspect the electronic address book manually to ensure the system has selected the email address relating to the intended recipient. However, often users will not manually select a user, incorrectly assuming the system has selected the correct email address or select the wrong address themselves. This results in an unintended recipient receiving the email, who then may delete the e-mail, or after recognizing erroneous receipt of the e-mail must be burdened with manually forward it to the intended recipient or replying to the sender informing of the unintentional receipt of the e-mail.

Therefore, a need exists for an e-mail system which minimizes misaddressed e-mails, and further is minimally invasive and easy to use.

### SUMMARY OF THE INVENTION

In an aspect of the invention, an e-mail routing system includes an e-mail program on a plurality of computers embodied in a computer readable medium readable by the computers. A network provides communication between the computers in an e-mail system. An e-mail router included in the e-mail system communicates with the network for routing e-mails each having a recipient e-mail address. A knowledge base embodied in computer readable medium readable by a knowledge base computer. The knowledge base contains reference data associated with each of the recipient e-mail addresses in the e-mail system. A content analyzer program and the e-mail program both embodied in computer readable medium readable by a system computer. The content analyzer program analyzing e-mail data within the contents of the e-mails before the router sends the e-mails to the recipient e-mail addresses. A relevancy score generator program embodied in computer readable medium readable by the system computer for generating a relevancy score for each e-mail, the relevancy score derived from associating the reference data corresponding to each possible recipient e-mail address with the e-mail data. A specified minimal relevancy score used by the relevancy score generator program such that analyzed low relevancy e-mails having a relevancy score less than the specified minimal relevancy score are each associated by the relevancy score generator program with a plurality of possible recipient e-mail addresses from the knowledge database specified as similar to the recipient e-mail address and having high relevancy scores and including the recipient e-mail address. The relevancy score generator program selects at least one recipient for each of the low relevancy e-mails from the possible recipient e-mail addresses having high relevancy scores, and the relevancy score generator program initiates sending each of the selected recipients their corresponding high relevancy score e-mail using the e-mail program. In another aspect, the relevancy score generator program selects a recipient for each of the low relevancy e-mails from the possible recipient e-mail addresses having the highest relevancy score, and the relevancy score generator program sends the selected recipient the corresponding highest relevancy score e-mail using the e-mail program.

In another aspect of the invention, a method for analyzing e-mail messages includes: loading an e-mail program on a plurality of computers in an e-mail system communicating via a network; routing e-mails for delivery to a recipient e-mail address; reading a knowledge base including reference data associated with each of the recipient e-mail addresses in the e-mail system; analyzing e-mail data within the contents of the e-mails before sending the e-mails to the recipient e-mail; generating a relevancy score for each e-mail by associating the reference data corresponding to the recipient e-mail address with the e-mail data; and specifying a minimal relevancy score used by the content analyzer program; associating e-mails having the relevancy score less than the specified minimal relevancy score with a plurality of possible recipient e-mail addresses from the knowledge database using the relevancy score generator program, and the plurality of possible recipient e-mail addresses including both the recipient e-mail address and e-mail addresses specified as similar to the recipient e-mail address which includes a high relevancy score; selecting at least one recipient from the possible recipient e-mail addresses having a high relevancy score; and sending each of the selected at least one recipients their corresponding high relevancy score e-mails using the e-mail program. In another aspect, the method includes selecting a highest relevancy score recipient, and sending the recipient the corresponding highest relevancy score e-mail using the e-mail program.

### BRIEF DESCRIPTION OF THE DRAWING

These and other objects, features and advantages of the present invention will become apparent from the following detailed description of illustrative embodiments thereof, which is to be read in connection with the accompanying drawing, in which:

The FIGURE is a block diagram of a content based routing system according to the present invention, including a network having a router, an email program on sender and recipient computer systems, a knowledge base on a knowledge base computer, and a system computer including a relevancy score generator program, a content analyzer program, and the email program.

### DETAILED DESCRIPTION OF THE INVENTION

An exemplary embodiment of an e-mail routing system and method 10 according to the present invention is shown in the FIGURE and includes an e-mail program 22 on a plurality of computers embodied as a sender's computer 16 and a recipient's computer 18. The e-mail program 22 is embodied on a computer readable medium (not shown), for example, a hard drive, or memory storage devices, readable by the computers 16, 18. The computers 16, 18 communicate with each other via communications links 44 connected to a network 40 providing communication between the computers 16, 18. The network 40 may be, for example, a client-server, or include the Internet, and may be a local area network (LAN) or a wide area network (WAN). The communications links 44 may include, for example, wired connections or wireless communications, and the network 40 may include, for example, a switch, router, or other network communication devices employing communication methods such as Ethernet, which is a family of frame based computer networking technologies for LANs standardized as IEEE (Institute of Electrical and Electronics Engineers) 802.3 which is hereby incorporated by reference in its entirety.

In the present embodiment of the invention, the network 40 includes an e-mail router 50 for routing e-mails which each have a recipient e-mail address. A knowledge base 14 is embodied on computer readable medium (not shown) readable by a knowledge base computer 12 connected to the network 40 via communications link 44. The knowledge base 14 includes reference data associated with the recipient e-mail addresses. The knowledge base 14 may be populated, for example, using e-mail searching programs, or using information supplied by users to identify their preferences such as expertise and interest.

Additionally, the e-mail routing system 10 according to the present invention may be selectively activated by a user supplying information to the system knowledge base 14 and allow incoming e-mails to be analyzed. Further, in one embodiment of the invention, e-mail users, such as an e-mail receiver activating the routing system, and/or a sender/receiver within the e-mail system having the routing system option available for receiving e-mails, enables the e-mail routing system by configuring one or more alternative e-mail addresses. Alternative e-mail addresses may be similar e-mail addresses for other people with similar names. The system 10 retrieves and analyzes data describing the interests of each alternative e-mail to derive a relevancy score attributed to the e-mail's addressee.

The reference data is collected or extracted using a content analyzer program 24 embodied on computer readable medium (not shown) readable by a system computer 20 which may be embodied as a server or the like. The e-mail program 22 is also embodied on computer readable medium of the system computer 20. The content analyzer program 24 analyzes e-mail data within the contents of the e-mails before the router 50 sends the e-mails to the recipient e-mail addresses. Routing e-mails may be accomplished using a router 50 as in the present embodiment, however, alternative embodiments may include, for example, a computer or server that functions as a router and may also include the relevancy score generator program and the content analyzer program. In another embodiment, the router 50 is programmed to access the relevancy score generator program 28 to generate a relevancy score

A relevancy score generator program 28 embodied on computer readable medium readable by the system computer 20 generates a relevancy score for each recipient e-mail address. The relevancy score is derived from associating the reference data stored in the knowledge base corresponding to each of the possible recipient e-mail addresses with the e-mail data extracted using the content analyzer program 24. The e-mail data can have, for example, a low or high relevancy score in relation to the data stored in the knowledge base. The relevancy score, as well as being based on e-mail content, can take into account the e-mail's author and other people listed in the email in the address field and other fields.

A specified minimal relevancy score is used by the content analyzer program 24 and can be specified by an administrator of the e-mail routing system. After analyzing e-mail data within the contents of the e-mails, or in an alternative embodiment, selected e-mails, the relevancy score generator program 28 compares the e-mail data with the reference data stored for the e-mail address and assigns a relevancy score to the recipient of the e-mail. If the relevancy score of an e-mail recipient is less than the specified minimal relevancy score, then the relevancy score generator program 28 associates e-mail data corresponding to the low relevancy score e-mail with reference data from possible recipient e-nail addresses. The reference data is from the knowledge database 14 which stores reference data for each e-mail address in the e-mail system 10.

The relevancy score generator program 28 also generates a list of possible recipient e-mail addresses. In an alternative embodiment, the router may generate a list of possible recipient e-mail addresses. The possible recipient e-mail addresses for one or more low relevancy score e-mails includes the recipient e-mail address and similar recipient e-mail addresses having high relevancy scores. The relevancy score generator program 28 selects one or more recipients from the possible recipient e-mail addresses having the highest relevancy scores, or, for example, one possible recipient e-mail having the highest relevancy score. The relevancy score generator program 28 then initiates sending the selected recipient(s) their corresponding e-mails using the e-mail program 22. The redirected emails may include a notice or indicator communicating that the email has been redirected, and may provide an easily accessible mechanism to direct the redirected e-mail back to the sender or to the original recipient bypassing any re-direct by the e-mail routing system 10.

In operation, the e-mail system and method 10 minimizes the receipt of misaddressed e-mails by analyzing e-mail messages. The system and method 10 includes loading the e-mail program 22 on a plurality of computers including the system computer 20, the sender's computer 16, and the recipient's computer 18 communicating via a network 40. For example, an e-mail sent from the sender's computer 16 using the e-mail program 22 is routed for delivery by the router 50 as part of the network 40 to a recipient e-mail address, which in this example is the recipient's e-mail program 22 on the recipient's computer 18.

Before the e-mail is routed to the recipient address, the system computer, communicating with the network 40 and router 50, uses the content analyzer program 24 to analyze e-mail data within the contents of the e-mails. The relevancy score generator program 28 communicates with the content analyzer program 24, and a relevancy score is generated using the relevancy score generator program 28 in the system computer 20 for each e-mail. The relevancy score generator reads the knowledge base 14 on the knowledge base computer 12 which includes reference data associated with each of the recipient e-mail addresses in the e-mail system.

The relevancy score generator program 28 associates the reference data corresponding to the recipient e-mail address with the e-mail data. A relevancy score for each e-mail recipient is generated by associating the reference data corresponding to the recipient e-mail address with the e-mail data. A minimal relevancy score is specified by an administrator and used by the relevancy score generator program 28. The relevancy score generator program 28 associates e-mails with a recipient having a relevancy score less than the specified minimal relevancy score with a plurality of possible recipient e-mail addresses from the knowledge database. The plurality of possible recipient e-mail addresses includes both the recipient e-mail address and e-mail addresses specified as similar to the recipient e-mail address and having relevancy scores higher than the specified minimal relevancy score, and/or having the highest relevancy scores. The e-mail recipient address having the highest relevancy score may be chosen as the recipient e-mail address, or a plurality of recipient e-mail addresses may be selected having high relevancy scores as recipient e-mail addresses from the possible recipient e-mail addresses. The relevancy score generator program 28 then initiates sending the e-mail to the selected recipient e-mail address using the e-mail program 22. In an alternative embodiment, the router 50 may select the recipient e-mail address and initiate sending the e-mail using the e-mail program 22.

Thereby, the system 10 of the present invention includes the system computer 20 analyzing an e-mail's content and testing it for relevancy to the recipient's address. If it does not meet the specified relevancy threshold, the e-mail is tested for relevancy to each possible alternative recipient. If the e-mail is more relevant to an alternative recipient, the e-mail is redirected to the most relevant recipient.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. An e-mail routing system, comprising:
an e-mail program on a plurality of computers embodied in a computer readable medium readable by the computers;
a network provides communication between the computers in an e-mail system;
an e-mail router included in the e-mail system communicates with the network for routing e-mails each having a recipient e-mail address;
a knowledge base embodied in computer readable medium readable by a knowledge base computer connected to the network, the knowledge base contains reference data associated with each of the recipient e-mail addresses in the e-mail system;
a content analyzer program and the e-mail program both embodied in computer readable medium readable by a system computer connected to the network, the content analyzer program analyzing e-mail data within the contents of the e-mails before the router sends the e-mails to the recipient e-mail addresses;
a relevancy score generator program embodied in computer readable medium readable by the system computer for generating a relevancy score for each e-mail in relation to the e-mail's recipient, the relevancy score derived from associating the reference data corresponding to each possible recipient e-mail address with the e-mail data; and
a specified minimal relevancy score used by the relevancy score generator program such that analyzed e-mails having a low recipient relevancy score of less than the specified minimal relevancy score are each associated by the relevancy score generator program with a plurality of possible recipient e-mail addresses from the knowledge database specified as similar to the recipient e-mail address of the e-mail and having high relevancy score recipients of more than the specified minimal relevancy score, and the plurality of possible recipient e-mail addresses including the recipient e-mail address, the relevancy score generator program selects at least one recipient having a relevancy score greater than the specified minimal relevancy score for each of the analyzed e-mails having a recipient relevancy score less than the specified minimal relevancy score, and the relevancy score generator program initiates sending at least one high relevancy score recipient a corresponding e-mail using the e-mail program.

2. The system of claim 1, wherein the relevancy score generator program selects a recipient having a highest relevancy score from the possible recipient e-mail addresses for each of the e-mails found to have low relevancy recipients.

3. A method for analyzing e-mail messages, comprising:
loading an e-mail program on a plurality of computers in an e-mail system communicating via a network;
routing e-mails for delivery to a recipient e-mail address;
reading a knowledge base including reference data associated with each of the recipient e-mail addresses in the e-mail system;
analyzing e-mail data within the contents of the e-mails before sending the e-mails to the recipient e-mail;
generating a relevancy score for each recipient of each e-mail by associating the reference data corresponding to the recipient e-mail address with the e-mail data; and
specifying a minimal relevancy score used by the content analyzer program;
associating e-mails having recipients with a low relevancy score being less than the specified minimal relevancy score with a plurality of possible recipient e-mail addresses from the knowledge database using the relevancy score generator program, and the plurality of possible recipient e-mail addresses including both the recipient e-mail address and e-mail addresses specified as similar to the recipient e-mail address having high relevancy scores being greater than the specified minimal relevancy score;
selecting at least one recipient from the possible recipient e-mail addresses having a high relevancy score; and
sending each of the selected high relevancy score recipients their corresponding e-mails using the e-mail program.

4. The method of claim 3, wherein one recipient is selected from the possible recipient e-mail addresses having the highest relevancy score; and
sending the selected recipient the corresponding e-mail to the highest relevancy score recipient using the e-mail program.
